(19) United States
(12) Patent Application Publication
(10) Pub. No.: US 2022/0303031 A1
(43) Pub. Date: Sep. 22, 2022

(54) METHOD, APPARATUS, ELECTRONIC DEVICE AND READABLE STORAGE MEDIUM FOR ESTIMATION OF A PARAMETER OF CHANNEL NOISE

(71) Applicant: Beijing University of Posts and Telecommunications, Haidian, Beijing (CN)

(72) Inventor: Norman Charles BEAULIEU, Haidian, Beijing (CN)

(21) Appl. No.: 16/972,432

(22) PCT Filed: Sep. 25, 2020
(86) PCT No.: PCT/CN2020/117683

§ 371 Date: Dec. 4, 2020

(51) Int. Cl. H04B 17/391

(52) U.S. Cl. CPC H04B 17/391

(57) ABSTRACT

Embodiment of the present disclosure provides a method, an apparatus, an electronic device and readable storage medium for estimation of a parameter of channel noise. The method for estimation of a parameter of channel noise comprises: obtaining noise samples from a communication channel; calculating a plurality of Logarithmic-Magnitude values for the noise samples; and estimating the parameter of the channel noise from the plurality of Logarithmic-Magnitude values.

### TECHNICAL FIELD

The present disclosure relates to the field of communication and computer technologies, and in particular, to a method, an apparatus, an electronic device, and a readable storage medium for estimation of a parameter of channel noise.

### BACKGROUND

The Cauchy distribution is widely used to model strong impulsive noise in communication. It is an excellent model for many kinds of noises, such as automotive noises and marine engine noises originating from spark plugs. It is valuable for describing the strongly impulsive noise generated by the commutation brushes present in all electric motors. The Cauchy distribution is pathological in the sense that no moments of order 1 or higher exist.

Maximum likelihood estimation (MLE) of the parameters of the Cauchy noise model is well known, but it is complex and requires solution of the maximum likelihood (ML) equations, which is highly complicated, time consuming and energy consuming.

In many cases, additive interference and noise are known to be zero-mean, alleviating any need to estimate a location parameter, so the focus is on estimating the scale parameter only. In this case, MLE again offers an optimal solution in the probabilistic sense. However, solving the MLE equations may be difficult or even intractable. A case in point is the Cauchy distribution for which the optimal ML estimation is highly complex because of the difficulty of solving the ML equations.

### SUMMARY

In order to at least partially solve the related technical problems, an embodiment of the present disclosure provides a method, an apparatus, an electronic device and a computer readable storage medium for estimation of a parameter of channel noise.

An aspect of the present disclosure provides a method for estimation of the parameter of the channel noise.

Specifically, the method for estimation of the parameter of channel noise includes:

obtaining noise samples from a communication channel;

calculating a plurality of Logarithmic-Magnitude values for the noise samples; and

estimating the parameter of the channel noise from the plurality of Logarithmic-Magnitude values.

Optionally, the channel noise comprises Cauchy noise.

Optionally, calculating the plurality of Logarithmic-Magnitude values for the noise samples comprises, for each of the noise samples:

calculating a magnitude value for the noise sample; and

calculating a logarithmic value for the magnitude value as the Logarithmic-Magnitude value for the noise sample.

Optionally, estimating the parameter from the plurality of Logarithmic-Magnitude values includes:

obtaining a median value of the plurality of Logarithmic-Magnitude values;

calculating an exponential value of the median value as the parameter of the channel noise.

Optionally, the estimation of the parameter of the channel noise is unbiased estimation.

Optionally, the communication channel comprises a wireless channel or a wired channel.

Optionally, the method further includes: generating new noise samples from the parameter of the channel noise.

Optionally, the method further includes: removing the new noise samples from signal samples obtained from the communication channel.

Another aspect of the present disclosure provides a channel noise parameter estimating apparatus, comprising:

a noise sample obtaining module configured to obtain noise samples from a communication channel;

a Logarithmic-Magnitude value calculating module configured to calculate a plurality of Logarithmic-Magnitude values for the noise samples; and

a channel noise parameter estimating module configured to estimate the parameter of the channel noise from the plurality of Logarithmic-Magnitude values.

Optionally, the apparatus further includes:

a new noise sample generating module configured to generate new noise samples from the parameter of the channel noise;

a new noise sample removing module configured to remove the new noise samples from signal samples obtained from the communication channel.

Another aspect of the present disclosure provides an electronic device comprising:

a processor; and

a memory configured to store executable instructions, which, when being executed by the processor, cause the processor to perform the method for estimation of the parameter of channel noise.

Another aspect of the present disclosure provides a computer readable storage medium storing executable instructions, which, when being executed by a processor, cause the processor to perform the method for estimation of the parameter of channel noise.

### BRIEF DESCRIPTION OF THE DRAWINGS

Other objects and advantages of the present disclosure will become more apparent from the detailed description of the unlimited implementation with the drawings. In the drawing:

FIG. 1 schematically shows a flowchart of a method for estimation of a parameter of channel noise according to an embodiment of the present disclosure;

FIG. 2 schematically shows a flowchart of a method for estimation of a parameter of channel noise according to an embodiment of the present disclosure;

FIG. 3a schematically shows probability density functions of Cauchy noise samples according to an embodiment of the present disclosure;

FIG. 3b schematically shows probability density functions of Logarithmic-Magnitude value of Cauchy noise samples according to an embodiment of the present disclosure;

FIG. 4 schematically shows a flowchart of a method for estimation of a parameter of channel noise according to an embodiment of the present disclosure;

FIG. 5 schematically shows a flowchart of a method for estimation of a parameter of channel noise according to an embodiment of the present disclosure;

FIG. 6 schematically shows a flowchart of a method for estimation of a parameter of channel noise according to an embodiment of the present disclosure;

FIG. 7 schematically shows a block diagram of an apparatus for estimation of a parameter of channel noise according to an embodiment of the present disclosure;

FIG. 8 schematically shows a block diagram of an apparatus for estimation of a parameter of channel noise according to an embodiment of the present disclosure;

FIG. 9 schematically shows a block diagram showing a structure of an electronic device according to an embodiment of the present disclosure;

FIG. 10 schematically shows a structural block diagram of a computer system suitable for implementing a method for estimation of a parameter of channel noise according to an embodiment of the present disclosure.

### DETAILED DESCRIPTION

Hereinafter, exemplary embodiments of the present disclosure will be described in details with reference to the accompanying drawings so that those of ordinary skill in the art can easily implement these embodiments. Further, portions that are not related to the description of the exemplary embodiments are omitted in the drawings for the sake of clarity.

In the present disclosure, it is to be understood that the terms such as “including” or “having” are intended to indicate the presence of features, numbers, steps, acts, components, parts or combinations thereof. The possibility of the presence or addition of a plurality of other features, numbers, steps, acts, components, parts or combinations thereof is not excluded.

It should also be noted that the embodiments of the present disclosure and the features of the embodiments may be combined with each other without conflict. Next, the present disclosure will be described in details with reference to the drawings and embodiments.

In the course of proposing the present disclosure, the inventors have found that maximum likelihood estimation (MLE) of the scale parameter of the Cauchy noise model is highly complicated, time consuming and energy consuming.

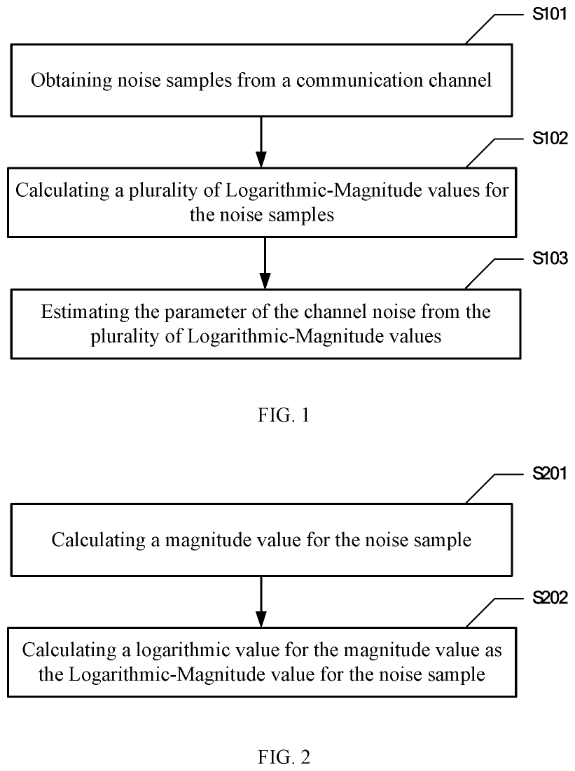

FIG. 1 schematically shows a flowchart of a method for estimation of a parameter of channel noise according to an embodiment of the present disclosure. The method comprises:

In step S101, obtaining noise samples from a communication channel;

In step S102, calculating a plurality of Logarithmic-Magnitude values for the noise samples; and

In step S103, estimating the parameter of the channel noise from the plurality of Logarithmic-Magnitude values.

According to an embodiment of the present disclosure, the noise samples are obtained from the communication channel. The parameter of the channel noise is obtained by calculating the plurality of Logarithmic-Magnitude (Logmag) values for the noise samples, and estimating the parameter of the channel noise from the plurality of Logmag values. After that, it is easy to analyze the property of the channel noise, and even easy to generate the noise and to remove the noise if necessary.

According to an embodiment of the present disclosure, the channel noise comprises Cauchy noise.

The Cauchy distribution is widely used to model strong impulsive noise in communication, such as automotive noises and marine engine noises originating from spark plugs. Estimation of the parameter of Cauchy noise is important to analyze the noise, and to enable easy regeneration of the noise and to remove the noise if necessary.

FIG. 2 schematically shows a flowchart of a method for estimation of a parameter of channel noise according to an embodiment of the present disclosure.

According to an embodiment of the present disclosure, FIG. 2 shows the detailed steps of step S102 for each noise sample in FIG. 1. The step S102 comprises:

In step S201, calculating a magnitude value for the noise sample; and

In step S202, calculating a logarithmic value for the magnitude value as the Logarithmic-Magnitude value for the noise sample.

The Cauchy probability density function (PDF) with translation parameter zero and with scale parameter b is given by

$${f}_{X} ( x ) = \frac{b}{π [ {b}^{2} + {x}^{2} ]} , - ∞ < x < ∞$$

The target of the embodiment is to estimate the scale parameter b from the noise samples Xᵢ, i=0, 1, . . . , N.

The distribution of Cauchy noise is pathological in the sense that no moments of order 1 or higher exist, so it is difficult to estimate b directly.

According to an embodiment of the present disclosure, the magnitude value of the noise sample is calculated, then the logarithmic value for the magnitude value is calculated as the Logarithmic-Magnitude value Zᵢ, i=0, 1, . . . , N for the noise sample Xᵢ, i=0, 1, . . . , N. Consequently, Zᵢ is got from

Zᵢ=ln(|Xᵢ|), i=1, . . . , N

It should be noted that the definition of Z₁ excludes the point, Xᵢ=0, because ln(x) is undefined at argument x=0. However, because the Cauchy PDF is continuous, the point Xᵢ=0 occurs with zero probability, so it carries little or no import in the analysis in the sequel.

The PDF of Zᵢ is

$${{f}_{Z}}_{i} ( {z}_{i} ) = \frac{2}{π} \cdot \frac{b}{{b}^{2} {e}^{- {z}_{i}} + {e}^{{z}_{i}}} , - ∞ < {z}_{i} < ∞$$

After calculating the Logarithmic-Magnitude value for the noise sample, it is much easier to estimate the scale parameter b.

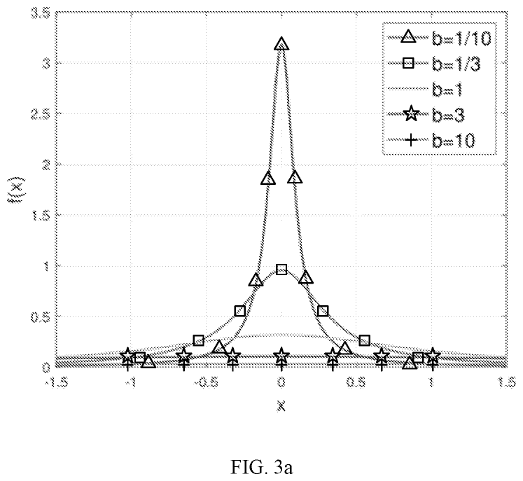

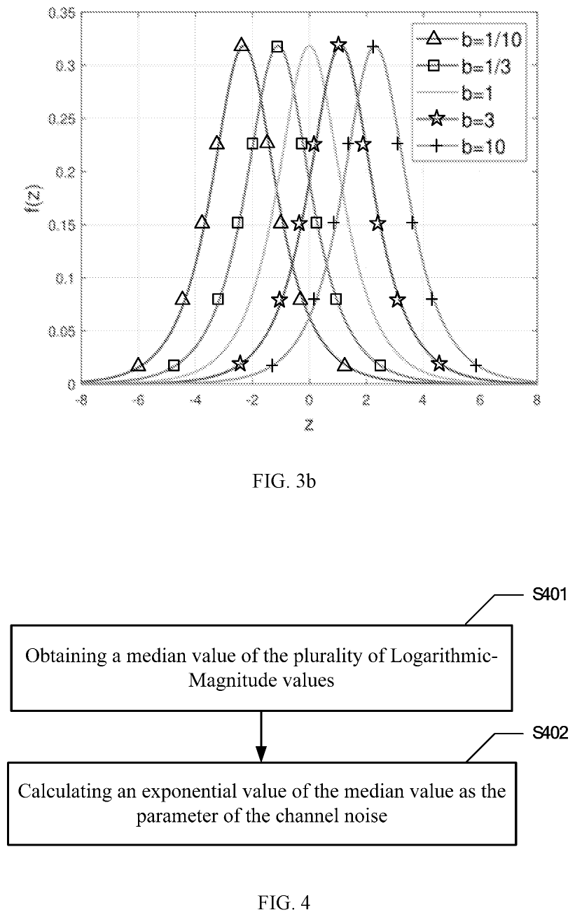

FIG. 3a schematically shows the probability density function of Cauchy noise samples according to an embodiment of the present disclosure.

FIG. 3b schematically shows the probability density function of Logarithmic-Magnitude values of Cauchy noise samples according to an embodiment of the present disclosure.

According to an embodiment of the present disclosure, it can be seen from FIG. 3a that the probability density functions (PDFs) of Cauchy noise samples x with different

$$b = \{ \frac{1}{10} , \frac{1}{3} , 1 , 3 , 10 \}$$

have a zero mean and different amplitudes. As a result, it is very difficult to estimate b.

After calculating the Logarithmic-Magnitude value z of Cauchy noise samples, the PDFs of z with different

$$b = \{ \frac{1}{10} , \frac{1}{3} , 1 , 3 , 10 \}$$

have different mean values, as can be seen from FIG. 3b. As a result, the estimation of b becomes much easier.

FIG. 4 schematically shows a flowchart of a method for estimation of a parameter of channel noise according to an embodiment of the present disclosure.

According to an embodiment of the present disclosure, FIG. 4 shows the detailed steps of step S103 in FIG. 1. The step S103 comprises:

In step S401, obtaining a median value of the plurality of Logarithmic-Magnitude values; and

In step S402, calculating an exponential value of the median value as the parameter of the channel noise.

According to an embodiment of the present disclosure, the estimation of b is

\hat{b}=exp{median(Zᵢ)}

According to an embodiment of the present disclosure, \hat{b} is an accurate estimation of parameter b.

The estimation of parameter b is less complex and less energy consuming than the Maximum likelihood estimation.

According to an embodiment of the present disclosure, the estimation of b is unbiased because

E[Zᵢ]=ln(b)

wherein E[Zᵢ] is the mean value of Zᵢ.

Let fₓ_{ᵢ}(xᵢ)=fₓ_{ᵢ}(xᵢ; b) and denote the random variable

$${Y}_{i} = \frac{{X}_{i}}{b} , i = 1 , … , N$$

so that

Xᵢ=bYᵢ, i=1, . . . , N

where the Yᵢ are normalized (by the scale parameter) random variables. The PDF

f_{Y}_{ᵢ}(yᵢ)=f_{Y}_{ᵢ}(yᵢ; b=1)

has the scale parameter b=1. Then,

E[Zᵢ]=E[ln(|Xᵢ|)]=E[ln(|bYᵢ|)]=ln(|b|)+E[ln(|Yᵢ|)]=ln(|b|)

where it is straightforward to prove that E[ln(|Yᵢ|)]=0.

Therefore, the Logmag-median estimation of the scale parameter b of the

Cauchy noise is unbiased, and the estimation of b is accurate when there are enough Cauchy noise samples. It is to be noted that different applications will require the estimation of b to have different accuracies. Hence, different embodiments can use more or fewer Cauchy noise samples taken from the channel. The number of Cauchy noise samples used in an embodiment is denoted by N (the plurality of Cauchy noise samples), and in the examples here N will take the typical values of 10, 50, 100, 1,000, 10,000.

The performance of the Logmag-median estimation with N Cauchy noise samples is compared with the ML estimation for an equal number of Cauchy noise samples in table I, II and III. In each column of the table, N is the number of Cauchy noise samples used in the estimation embodiment. The performances are assessed using simulation with 1,000,000 trials for each entry in the tables to ensure convergence with high probability to four exact significant figure accuracy.

TABLE I
Performance of the Logmag-median and ML estimation for b = ⅓

| N | 10 | 100 | 1,000 | 10,000 |
|---|---|---|---|---|
| Mean MLE | 0.3679 | 0.3370 | 0.3336 | 0.3334 |
| Variance MLE | 0.03283 | 0.002308 | 0.0002217 | 0.00002216 |
| Mean Logmag-median | 0.3748 | 0.3373 | 0.3337 | 0.3334 |
| Variance Logmag-median | 0.04002 | 0.002807 | 0.0002747 | 0.00002720 |
| Ratio of Means Logmag-median/MLE | 1.014 | 1.001 | 1.000 | 0.9999 |
| Ratio of Variances Logmag-median/MLE | 1.219 | 1.216 | 1.239 | 1.228 |

TABLE II
Performance of the Logmag-median and ML estimation for b = 1

| N | 10 | 100 | 1,000 | 10,000 |
|---|---|---|---|---|
| Mean MLE | 1.110 | 1.010 | 1.001 | 1.000 |
| Variance MLE | 0.2972 | 0.02096 | 0.002014 | 0.0001999 |
| Mean Logmag-median | 1.126 | 1.012 | 1.001 | 1.000 |
| Variance Logmag-median | 0.3592 | 0.02550 | 0.002479 | 0.0002465 |
| Ratio of Means Logmag-median/MLE | 1.015 | 1.002 | 1.000 | 1.000 |
| Ratio of Variances Logmag-median/MLE | 1.209 | 1.217 | 1.231 | 1.233 |

TABLE III
Performance of the Logmag-median and ML estimation for b = 3

| N | 50 | 100 | 1,000 | 10,000 |
|---|---|---|---|---|
| Mean MLE | 3.061 | 3.030 | 3.003 | 3.000 |
| Variance MLE | 0.3873 | 0.1859 | 0.01805 | 0.001790 |
| Mean Logmag-median | 3.074 | 3.037 | 3.004 | 3.001 |
| Variance Logmag-median | 0.4741 | 0.2317 | 0.02230 | 0.002221 |
| Ratio of Means Logmag-median/MLE | 1.004 | 1.002 | 1.000 | 1.000 |
| Ratio of Variances Logmag-median/MLE | 1.224 | 1.246 | 1.235 | 1.241 |

It can be observed from table I, II, and III that the variances of the Logmag-median estimation are only about 22%, 23%, and 24% greater than the variances of the ML estimation, for b=⅓,1 and 3 respectively. On the other hand, the Logmag-median estimation offers huge reductions in complexity and computation time over the ML estimation.

Table IV shows the performance of the Logmag-median and ML estimations using equal energies for b=1, and N is number of Cauchy noise samples taken from the communications channel in the embodiment.

TABLE IV
Performance of the Logmag-median and ML estimation using
equal energies for b = 1

| N | 50 | 100 | 1,000 | 10,000 |
|---|---|---|---|---|
| Mean MLE | 1.110 | 1.010 | 1.001 | 1.000 |
| Variance MLE | 0.2972 | 0.02096 | 0.002014 | 0.0001999 |
| Mean Logmag-median | 1.000 | 1.000 | 1.000 | 1.000 |
| Variance Logmag-median | 0.0004856 | 0.00004846 | 0.000004847 | 0.0000004849 |
| Ratio of Means Logmag-median/MLE | 0.9014 | 0.9897 | 0.9990 | 1.000 |
| Ratio of Variances Logmag-median/MLE | 0.001634 | 0.002312 | 0.002407 | 0.002426 |

It can be observed from table IV that with approximately the same computation time (energy), the Logmag-median estimation has variance less than 1/400 of the variance of the ML estimation. The improvement of the Logmag-median scale parameter estimation over the ML estimation, when viewed on a time or energy basis, is very huge. Thus, the proposed Logmag-median scale parameter estimation consumes less time or energy than the ML estimation with the same noise samples, and gives more accurate estimation.

According to an embodiment of the present disclosure, the communication channel comprises a wireless channel or a wired channel The Cauchy noise such as automotive noises and marine engine noises originating from spark plugs can be obtained from the wireless channel or the wired channel. The method according to embodiments of the present disclosure is suitable for the noise from the two kinds of channels.

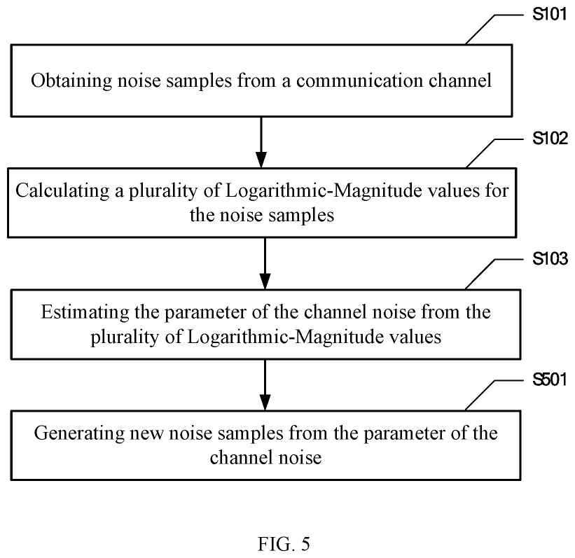

FIG. 5 schematically shows a flowchart of a method for estimation of a parameter of channel noise according to an embodiment of the present disclosure.

In addition to the steps S101, S102, S103 in FIG. 1, FIG. 5 shows a further step S501, comprising generating new noise samples from the parameter of the channel noise.

Since the parameter b has been estimated in step S101˜S103, new noise samples can be generated from the estimated parameter b. The new noise samples can be used in the noise removal from signal samples from the communication channel

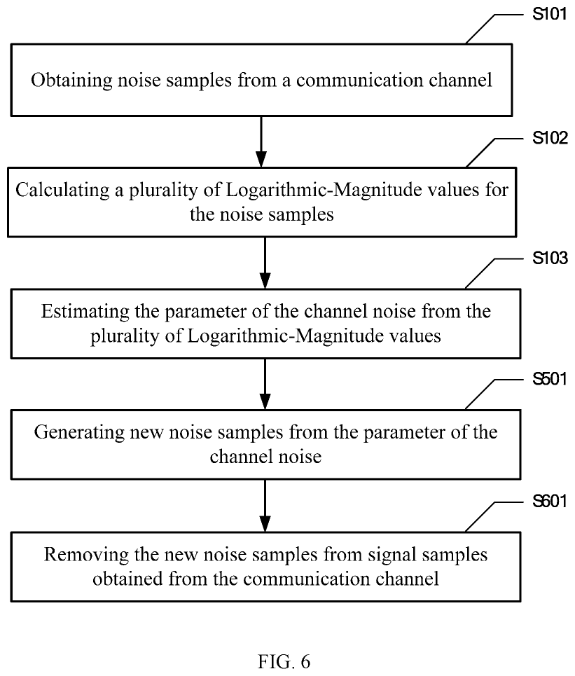

FIG. 6 schematically shows a flowchart of a method for estimation of a parameter of channel noise according to an embodiment of the present disclosure.

In addition to the steps S101, S102, S103, S501 in FIG. 5, FIG. 6 shows a further step S601, comprising removing the new noise samples from signal samples obtained from the communication channel

After generating the new noise samples in step S501, the new noise samples can be removed from the signal samples obtained from the communication channel. Therefore, a clear signal can be obtained with the proposed Logmag-median scale noise parameter estimation, noise generation and removal, with less complexity and less energy consumption than the ML estimation.

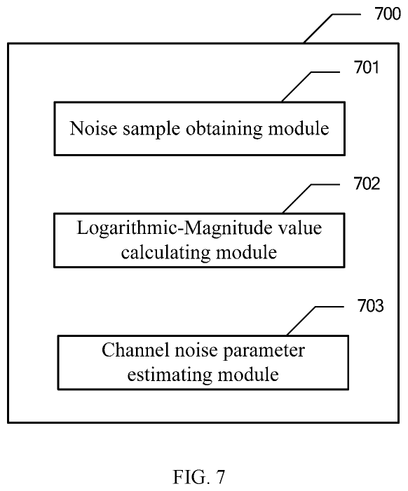

FIG. 7 schematically shows a block diagram of an apparatus for estimation of a parameter of channel noise according to an embodiment of the present disclosure.

As shown in FIG. 7, the apparatus for estimation of a parameter of channel noise 700 includes:

a noise sample obtaining module 701, configured to obtain noise samples from a communication channel;

a Logarithmic-Magnitude value calculating module 702, configured to calculate a plurality of Logarithmic-Magnitude values for the noise samples; and

a channel noise parameter estimating module 703, configured to estimate the parameter of the channel noise from the plurality of Logarithmic-Magnitude values.

According to an embodiment of the present disclosure, the apparatus for estimation of a parameter of channel noise 700 leads to noise parameter estimation with less complexity and less energy consumption than the ML estimation.

According to an embodiment of the present disclosure, the channel noise comprises Cauchy noise.

According to an embodiment of the present disclosure, calculating the plurality of Logarithmic-Magnitude values for the noise samples comprises, for each of the noise samples: calculating a magnitude value for the noise sample; and calculating a logarithmic value for the magnitude value as the Logarithmic-Magnitude value for the noise sample.

According to an embodiment of the present disclosure, estimating the parameter from the plurality of Logarithmic-Magnitude values comprises: obtaining a median value of the plurality of Logarithmic-Magnitude values; calculating an exponential value of the median value as the parameter of the channel noise.

According to an embodiment of the present disclosure, the estimation of the parameter of the channel noise is unbiased estimation.

According to an embodiment of the present disclosure, the communication channel comprises a wireless channel or a wired channel

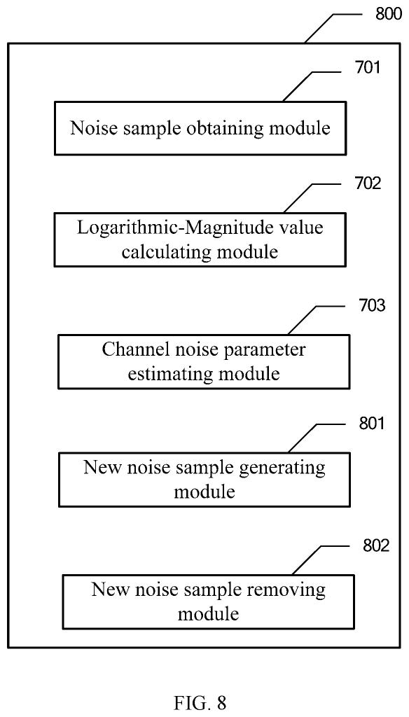

FIG. 8 schematically shows a block diagram of an apparatus for estimation of a parameter of channel noise according to an embodiment of the present disclosure.

As shown in FIG. 8, the apparatus for estimation of a parameter of channel noise 800 includes the same modules 701, 702, 703 as in FIG. 7, and further includes new modules:

a new noise sample generating module 801, configured to generate new noise samples from the parameter of the channel noise;

a new noise sample removing module 802, configured to remove the new noise samples from signal samples obtained from the communication channel.

According to an embodiment of the present disclosure, after generating the new noise samples in module 801, the new noise samples can be removed from the signal samples obtained from the communication channel in module 802. So the clear signal can be obtained with the proposed Logmag-median scale noise parameter estimation, noise generation and removal, with less complexity and less energy consumption than the ML estimatior.

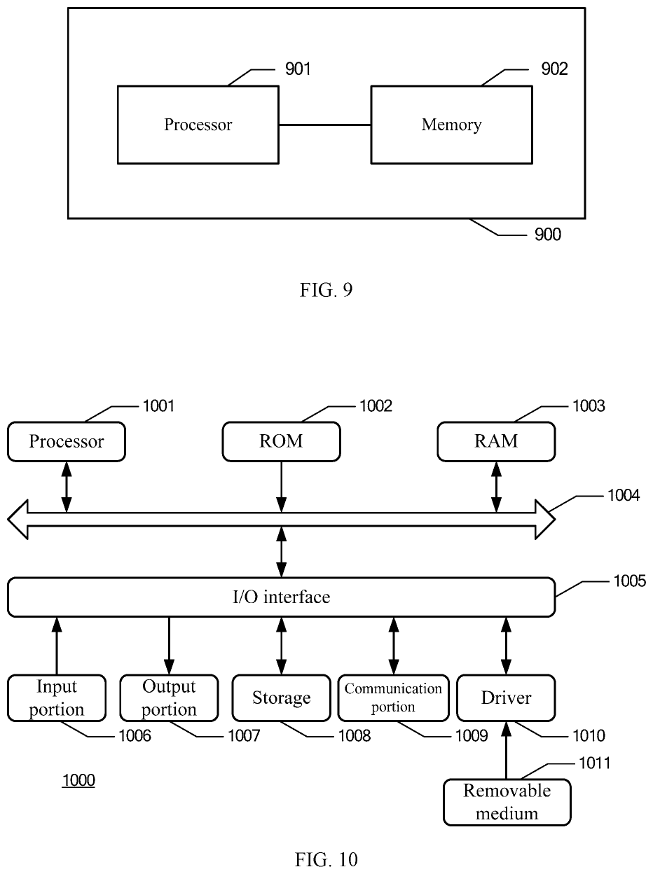

FIG. 9 schematically shows a block diagram showing the structure of an electronic device according to an embodiment of the present disclosure.

As shown in FIG. 9, the electronic device 900 can include a processor 901 and a memory 902. The memory 902 is configured to store one or more computer instructions. The one or more computer instructions stored in the memory 902 are executed by the processor 901 to implement the following steps:

Obtaining noise samples from a communication channel

Calculating a plurality of Logarithmic-Magnitude values for the noise samples.

Estimating the parameter of the channel noise from the plurality of Logarithmic-Magnitude values.

According to an embodiment of the present disclosure, the channel noise comprises Cauchy noise.

According to an embodiment of the present disclosure, calculating the plurality of Logarithmic-Magnitude values for the noise samples comprises, for each of the noise samples:

calculating a magnitude value for the noise sample.

calculating a logarithmic value for the magnitude value as the Logarithmic-Magnitude value for the noise sample.

According to an embodiment of the present disclosure, estimating the parameter from the plurality of Logarithmic-Magnitude values comprises:

obtaining a median value of the plurality of Logarithmic-Magnitude values;

calculating an exponential value of the median value as the parameter of the channel noise.

According to an embodiment of the present disclosure, the estimation of the parameter of the channel noise is unbiased estimation.

According to an embodiment of the present disclosure, the communication channel comprises a wireless channel or a wired channel

According to an embodiment of the present disclosure, the one or more computer instructions stored in the memory 902 can also be executed by the processor 901 to implement the following steps:

Generating new noise samples from the parameter of the channel noise.

According to an embodiment of the present disclosure, the one or more computer instructions stored in the memory 902 can also be executed by the processor 901 to implement the following steps:

Removing the new noise samples from signal samples obtained from the communication channel.

FIG. 10 schematically shows a structural block diagram of a computer system suitable for implementing a method for estimation of a parameter of channel noise according to an embodiment of the present disclosure.

As shown in FIG. 10, computer system 1000 includes a processor (CPU) 1001 that can perform the above method according to a program stored in read only memory (ROM) 1002 or a program loaded from the storage 1008 to the random storage memory (RAM) 1003. In the rain 1003, various programs and data are also stored that are required for the operation of the system 1000. The CPU 1001, the ROM 1002, and the RAM 1003 are connected to each other through a bus 1004. An input/output (I/O) interface 1005 is also coupled to the bus 1004.

The following components are connected to the I/O interface 1005: an input portion 1006 including keyboard, mouse, etc., an output portion 1007 including cathode ray tube (CRT), liquid crystal display (LCD), and speaker, etc., a storage 1008 including hard disk or the like, and a communication portion 1009 including network interface card such as LAN card, modem, or the like. The communication portion 1009 performs communication processing via a network such as the Internet. Driver 1010 is also coupled to I/O interface 1005 as needed. A removable medium 1011, such as magnetic disk, optical disk, magneto-optical disk, semiconductor memory or the like, is mounted on the driver 1010 as needed so that a computer program read therefrom is installed into the storage portion 1008 as needed.

Additionally, in accordance with embodiments of the present disclosure, the methods described above may be implemented as a computer software program. For example, an embodiment of the present disclosure includes a computer program product comprising a computer program tangibly embodied on a readable medium therewith, the computer program comprises program code for performing the method described above. In such an embodiment, the computer program can be downloaded and installed from the network via the communication portion 1009, and/or installed from removable media 1011.

The flowcharts and block diagrams in the figures illustrate the architecture, functionality, and operation of possible implementations of systems, methods and computer program products in accordance with various embodiments of the present disclosure. In this regard, each block of the flowchart or block diagram can represent a module, a program segment, or a portion of code that includes one or more of the executable instructions to implement predetermined logical functionality. It should also be noted that in some alternative implementations, the functions noted in the blocks may also occur in a different order than that illustrated in the drawings. For example, two successively represented blocks may in fact be executed substantially in parallel, and they may sometimes be executed in the reverse order, depending upon the functionality involved. It is also noted that each block of the block diagrams and/or flowcharts, and combinations of blocks in the block diagrams and/or flowcharts, can be implemented in a dedicated hardware-based system that performs the specified function or operation. Or it can be implemented by a combination of dedicated hardware and computer instructions.

The units or modules described in the embodiments of the present disclosure may be implemented by software or by programmable hardware. The described units or modules may also be provided in a processor, the names of the units or modules do not in any way constitute a limitation of the unit or module itself.

In another aspect, the present disclosure further provides a computer readable storage medium, which may be a computer readable storage medium included in the apparatus in the above embodiment; or may exist separately, not being a computer readable storage medium that is assembled into the device. A computer readable storage medium stores one or more programs that are used by one or more processors to perform the methods described in the present disclosure.

The above description is only a preferred embodiment herein and a description of the principles of the applied technology. It should be understood by those of ordinary skill in the art that the scope of the invention referred to in the present disclosure is not limited to the specific combination of the above technical features, and should also be covered by the other technical solutions formed by any combination of their equivalent features with the above technical features without departing from the inventive concept. For example, technical solutions generated by the alternative change of the above features with but not limited to the technical features having similar functions disclosed in the present disclosure.

What is claimed is:

1. A method for estimation of a parameter of channel noise, comprising:
obtaining noise samples from a communication channel;
calculating a plurality of Logarithmic-Magnitude values for the noise samples; and
estimating the parameter of the channel noise from the plurality of Logarithmic-Magnitude values.

2. The method according to claim 1, wherein the channel noise comprises Cauchy noise.

3. The method according to claim 2, wherein the calculating the plurality of Logarithmic-Magnitude values for the noise samples comprises, for each of the noise samples:
calculating a magnitude value for the noise sample; and
calculating a logarithmic value for the magnitude value as the Logarithmic-Magnitude value for the noise sample.

4. The method according to claim 3, wherein the estimating the parameter from the plurality of Logarithmic-Magnitude values comprises:
obtaining a median value of the plurality of Logarithmic-Magnitude values;
calculating an exponential value of the median value as the parameter of the channel noise.

5. The method according to claim 4, wherein the estimation of the parameter of the channel noise is unbiased estimation.

6. The method according to claim 1, wherein the communication channel comprises a wireless channel or a wired channel

7. The method according to claim 1, further comprising:
generating new noise samples from the parameter of the channel noise.

8. The method according to claim 7, further comprising:
removing the new noise samples from signal samples obtained from the communication channel.

9. A channel noise parameter estimating apparatus, comprising:
a noise sample obtaining module configured to obtain noise samples from a communication channel;
a Logarithmic-Magnitude value calculating module configured to calculate a plurality of Logarithmic-Magnitude values for the noise samples; and
a channel noise parameter estimating module configured to estimate the parameter of the channel noise from the plurality of Logarithmic-Magnitude values.

10. The apparatus according to claim 9, further comprising:
a new noise sample generating module configured to generate new noise samples from the parameter of the channel noise;
a new noise sample removing module configured to remove the new noise samples from signal samples obtained from the communication channel.

11. A electronic device comprising:
a processor; and
a memory configured to store executable instructions, which, when being executed by the processor, cause the processor to perform the method for estimation of a parameter of channel noise according to any one of claims 1-8.

12. A computer readable storage medium storing executable instructions, which, when being executed by a processor, cause the processor to perform the method for estimation of a parameter of channel noise according to any one of claims 1-8.
